(19) United States
(12) Patent Application Publication
(10) Pub. No.: US 2026/0330139 A1
(43) Pub. Date: Oct. 22, 2026

(54) TEXT GENERATION USING SELECTIVE ATTENTION

(71) Applicant: ADOBE INC., SAN JOSE, CA (US)

(72) Inventors: Chien Van Nguyen, Eugene, OR (US); Ruiyi Zhang, Mountain View, CA (US); Hanieh Deilamsalehy, Issaquah, WA (US); Puneet Mathur, Sunnyvale, CA (US); Ryan A. Rossi, San Jose, CA (US); Trung Huu Bui, San Jose, CA (US); Viet Dac Lai, San Jose, CA (US); Franck Dernoncourt, Seattle, WA (US)

(21) Appl. No.: 19/185,986

(22) Filed: Apr. 22, 2025

(51) Int. Cl. G06F 40/284; G06N 3/0475

(52) U.S. Cl. CPC G06F 40/284; G06N 3/0475

(57) ABSTRACT

A method, apparatus, non-transitory computer readable medium, and system for data processing includes obtaining an input prompt comprising a sequence of input tokens, performing a linear attention process on the sequence of input tokens to obtain a sequence of hidden representation tokens, performing a gating process on the sequence of hidden representation tokens to determine a selected token from the sequence of hidden representation tokens, performing a causal self-attention process on the selected token based on the gating process to obtain an augmented sequence of hidden representation tokens, and generating a response to the input prompt comprising a sequence of output tokens based on the augmented sequence of hidden representation tokens.

### BACKGROUND

The following relates generally to text generation using machine learning, and more specifically to text generation using selective attention. Attention refers to a mechanism that allows a machine learning model to focus on different parts of a sequence of tokens when making predictions based on the sequence. Causal self-attention is an attention variant that is popularly used for natural language processing (NLP) tasks such as text generation. However, causal self-attention has quadratic complexity and is therefore computationally expensive.

Meanwhile, linear attention is an attention variant that is linearly complex, and therefore less computationally expensive than causal self-attention. However, linear attention does not capture complex or long-range dependencies among tokens as well as causal self-attention, and is therefore less suitable for NLP tasks that involve complex, long-range dependencies such as in-context retrieval.

### SUMMARY

Systems and methods are described for generating a response to an input prompt using selective attention. In some embodiments, a machine learning model of a data processing system performs a linear attention process on a sequence of input tokens of the input prompt to obtain a sequence of hidden representation tokens, selects a token of the sequence of hidden representation tokens, performs a causal self-attention process on the selected token to obtain an augmented sequence of hidden representation tokens, and generates the response based on the augmented sequence of hidden representation tokens.

By using linear attention, the data processing system minimizes a computation expense of generating the response. By selecting the token to perform the causal self-attention process on, the data processing system uses causal self-attention on a token that would benefit from attending to each previous token in the input sequence due to complex or long-range dependencies, while avoiding using causal self-attention for tokens that would not similarly benefit from it. Therefore, the selective application of causal self-attention allows the data processing system to efficiently minimize a computational expense of generating an accurate response.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The Detailed Description is described with reference to the accompanying figures. Entities represented in the figures are indicative of one or more entities and thus reference is made interchangeably to single or plural forms of the entities in the discussion.

FIG. 1 shows an example of a data processing system according to aspects of the present disclosure.

FIG. 2 shows an example of a method for generating a response using selective attention according to aspects of the present disclosure.

FIG. 3 shows an example of a data processing system for performing selective attention according to aspects of the present disclosure.

FIG. 4 shows an example of a machine learning model according to aspects of the present disclosure.

FIG. 5 shows an example of a causal attention process according to aspects of the present disclosure.

FIG. 6 shows an example of a method for generating a response using a gating process according to aspects of the present disclosure.

FIG. 7 shows a comparative example of attention maps according to aspects of the present disclosure.

FIG. 8 shows an example of a method for generating a response using a selected token according to aspects of the present disclosure.

FIG. 9 shows an example of a flow diagram depicting an algorithm as a step-by-step procedure for training a machine learning model according to aspects of the present disclosure

FIG. 10 shows an example of a computing device according to aspects of the present disclosure.

FIG. 11 shows an example of a data processing apparatus according to aspects of the present disclosure.

### DETAILED DESCRIPTION

### Overview

Attention refers to a mechanism that allows a machine learning model to focus on different parts of a sequence of tokens when making predictions based on the sequence. Causal self-attention is an attention variant that is popularly used (e.g., by transformers) for natural language processing (NLP) tasks such as text generation. However, causal self-attention has quadratic complexity and is therefore computationally expensive.

Meanwhile, linear attention (including generalizations of linear attention, such as structured state space models and variants thereof, such as Mamba-2) is an attention variant that is linearly complex, and therefore less computationally expensive than causal self-attention. However, linear attention does not capture complex or long-range dependencies among tokens as well as causal self-attention, and is therefore less suitable for NLP tasks that involve complex, long-range dependencies such as in-context retrieval.

Accordingly, aspects of the present disclosure describe systems and methods for generating text using selective attention. In some embodiments, a machine learning model of a data processing system performs a linear attention process on a sequence of input tokens of the input prompt to obtain a sequence of hidden representation tokens, selects a token of the sequence of hidden representation tokens (e.g., using a gating process), performs a causal self-attention process on the selected token to obtain an augmented sequence of hidden representation tokens, and generates the response based on the augmented sequence of hidden representation tokens.

By using linear attention, the data processing system minimizes a computation expense of generating the response. By selecting the token to perform the causal self-attention process on, the data processing system uses causal self-attention on a token that would benefit from attending to each previous token in the input sequence due to complex or long-range dependencies, while avoiding using causal self-attention for tokens that would not similarly benefit from it. Therefore, the selective application of causal self-attention enables the data processing system to efficiently minimize a computational expense of generating an accurate response.

Examples of existing data processing systems include a transformer, a baseline Mamba-2 model, and a baseline hybrid model that includes a causal self-attention layer and a Mamba-2 layer that does not select tokens to be processed by the causal self-attention layer, but rather processes each token using both the Mamba-2 layer and the causal self-attention layer.

The data processing system outperforms the baseline systems on a zero-shot language understanding task, with a widening performance gap as model size increases. Furthermore, the data processing system outperforms the Mamba-2 and hybrid baselines on an in-context retrieval task. While the baseline transformer excels at memory-intensive tasks, the baseline transformer is constrained by linear memory scaling with sequence length, limiting an effectiveness of the transformer for processing very long sequences. In contrast, the data processing system maintains constant memory usage regardless of sequence length, offering a more efficient solution than baseline transformers for processing extensive documents. Finally, the data processing system outperforms the baseline models in a long-context extrapolation task, demonstrating a lowest latency among the tested models, with linear scaling across sequence lengths.

### Terminology Examples

“Attention” refers to a mechanism that allows a machine learning model to focus on different parts of a sequence of tokens when making predictions. The attention mechanism works by computing attention scores that determine how much importance each token of a sequence should have relative to other tokens in the sequence.

In “causal self-attention”, or a “causal self-attention process”, the tokens are used to compute three different matrices: query (Q), key (K), and value (V). The query matrix represents the token currently being processed, the key matrix represents each of the tokens in the sequence, and the value matrix includes the actual information of the tokens.

The causal self-attention mechanism calculates attention scores by taking the dot product of the query and key matrices, determining how closely related each token is to every preceding token in the sequence. These scores are then scaled and passed through a softmax function to create attention weights, which sum to one and determine how much influence each token has on the final output. The value matrix is then aggregated using the attention weights in a weighted sum, such that the causal self-attention mechanism focuses more on tokens with higher attention scores, thereby enabling the causal self-attention mechanism to dynamically capture relationships between words, including complex, long-range dependencies. This results in an O(n²) complexity due to the pairwise interactions, where n is the sequence length. While powerful, this quadratic complexity makes causal self-attention computationally expensive for long sequences, as the memory and computation grow rapidly.

“Linear attention”, or a “linear attention process”, on the other hand, is a more efficient attention variant that approximates self-attention while reducing its complexity to O(n). Instead of computing full pairwise dot-product attention, linear attention modifies the attention mechanism by using kernel functions or low-rank approximations of dot-product attention, allowing the attention computation to be performed incrementally rather than all at once.

However, despite its computational efficiency, linear attention has notable limitations compared to softmax attention as used in causal self-attention. The dot-product approximation in linear attention lacks the nonlinear normalization of softmax, often resulting in a more uniform distribution of attention weights. This uniformity can impair the ability of the linear attention mechanism to focus sharply on specific and relevant tokens. Consequently, linear attention models may underperform in tasks requiring precise in-context retrieval or focused attention on particular input segments.

In some embodiments, “linear attention” includes a generalization of linear attention, such as is provided by structured state space models (SSMs). A structured SSM is a machine learning architecture designed to efficiently model long-range dependencies in sequential data, serving as an alternative to transformers and recurrent neural networks (RNNs). SSMs describe how a system evolves over time using latent states. In an SSM, a sequence is processed through a hidden state representation, which evolves according to a set of linear recurrence equations. The SSM is defined by the state evolution equation and an observation equation. The state evolution equation updates the hidden state over time, while the observation equation maps the hidden state to the output.

As used herein, “input prompt” is an input to a machine learning model. An input prompt includes a sequence of input tokens. A “token” refers to a tokenized representation of a word or character, or a numerical representation of the tokenized representation of a word or character. For example, the sentence “Hello tokenization!” might initially be split into token sequence [“Hello”, “tokenization”, “!”]. The words of the input may be further divided into meaningful subunits. For example, “tokenization” might become [“token”, “ization”, “!”]. Each token may be mapped to a unique integer identifier. As used herein, the term “token” refers to either the tokenized representation or the unique integer identifier for the token. An input prompt may be obtained by tokenizing an input such as a text string.

An example of the data processing system is used in an in-context retrieval context. In the example, a user provides a document to data processing system and a query asking the data processing system to summarize the document. The data processing system tokenizes the query and the document to obtain an input prompt. The data processing system uses the machine learning model to process the tokens of the input prompt using linear attention and to selectively process some of the tokens using causal self-attention. The machine learning model generates a response based on the processed tokens, and the data processing system provides the response to the user. The causal self-attention process enables the data processing system to properly account for complex, long-range dependencies included in the input prompt, while the linear attention process minimizes a processing time for attending to the non-selected tokens. Because the causal self-attention process is selectively performed, rather than on each token, the accuracy of the response is maximized while minimizing the computational cost of generating the response.

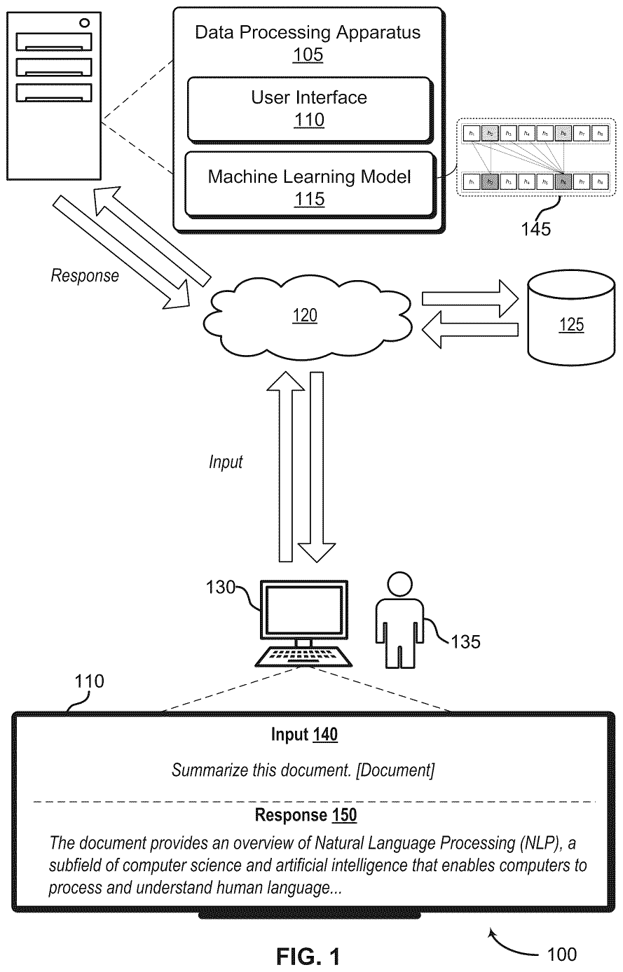

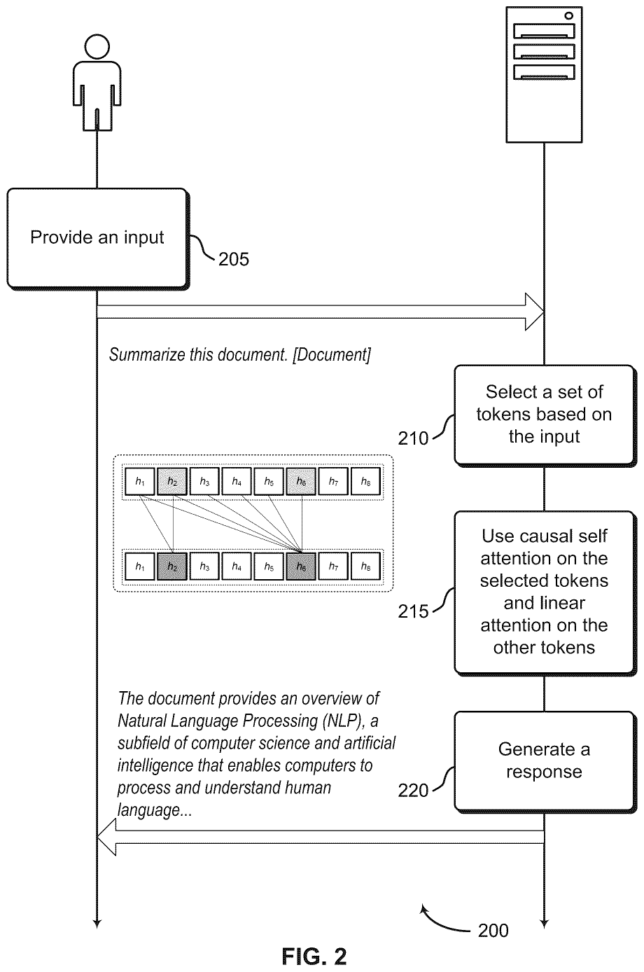

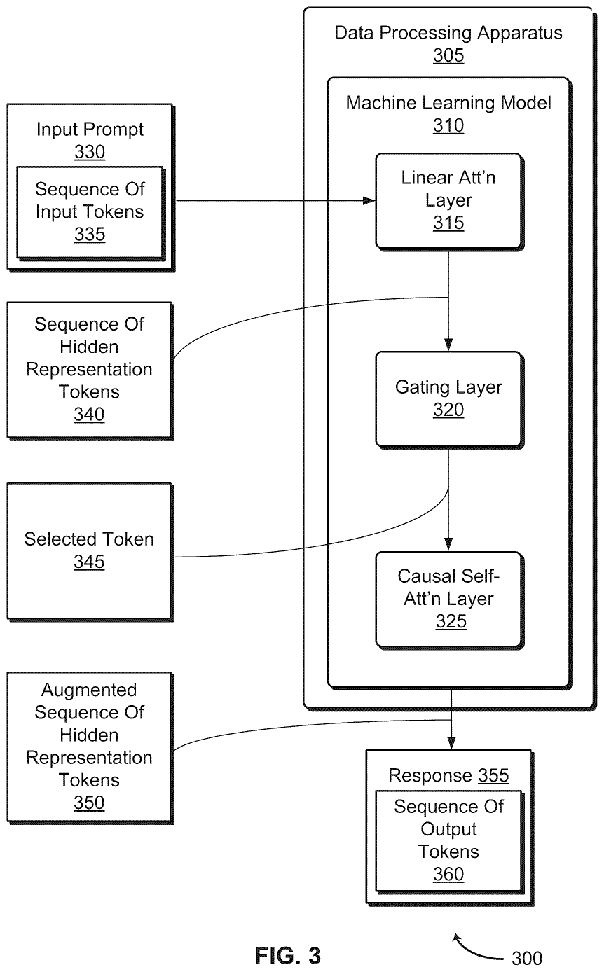

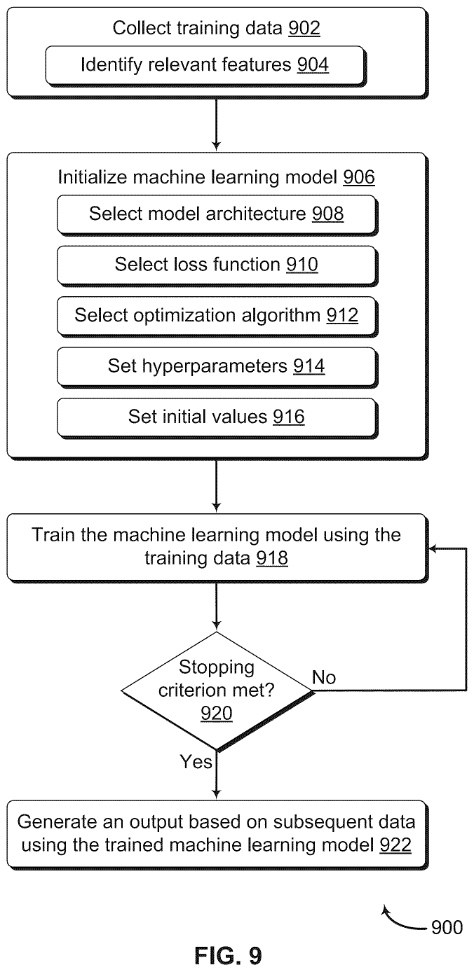

Further examples of the present disclosure in a response generation context are provided with reference to FIGS. 1-2. Details regarding the architecture of the data processing system are provided with reference to FIGS. 3-5 and 10-11. Examples of processes for generating a response are provided with reference to FIGS. 2 and 6-8. Examples of a process for training the machine learning model are provided with reference to FIG. 9.

### Data Processing System

FIG. 1 shows an example of a data processing system 100 according to aspects of the present disclosure. The example shown includes data processing system 100, user device 130, user 135, input 140, selective attention process 145, and response 150. Data processing system 100 is an example of, or includes aspects of, the corresponding element described with reference to FIG. 3. In one aspect, data processing system 100 includes data processing apparatus 105, cloud 120, and database 125. In one aspect, data processing apparatus 105 includes user interface 110 and machine learning model 115.

Referring to FIG. 1, data processing system 100 uses a combination of linear attention and causal self-attention to selectively process a sequence of tokens. Linear attention (e.g., dot-product attention), including a generalization of linear attention provided by a structured state-space model, is computationally efficient but produces sub-optimal results for tokens that have complex or long-range dependencies with other tokens. On the other hand, causal self-attention (e.g., softmax attention) effectively accounts for complex or long-range dependencies among tokens, but is computationally inefficient compared to linear attention. By using a gating process to select tokens that would benefit from causal self-attention, the data processing system effectively accounts for complex or long-range dependencies among tokens while maximizing computational efficiency. Therefore, data processing system 100 is able to efficiently generate an accurate response to an input prompt.

For example, a user (such as user 135) provides a text input to data processing apparatus 105 via user interface 110 displayed on a user device (such as user device 130). In some embodiments, the input may include text, and may also include context, or information that can be used by machine learning model 115 in addition to information stored in a parametric memory of machine learning model 115 to generate a response. For example, input 140 includes the text string “Summarize this document” and a document to be used as context. A “document” is a piece of written, printed, or electronic matter that includes information. Examples of a document include a word processing document file, a text document file, a Portable Document Format (PDF) file, a web page, a spreadsheet file, a presentation slide file, a smartphone or tablet app, a computer file folder, etc.

Data processing apparatus 105 tokenizes the input (e.g., converts the input to a sequence of representative numbers) to obtain a sequence of input tokens. Machine learning model 115 uses selective attention process 145 to apply linear attention to the sequence of input tokens to obtain a sequence of hidden representation tokens and to apply causal self-attention to selected tokens of the sequence of hidden representation tokens to obtain an augmented sequence of hidden representation tokens, as described in further detail with reference to FIG. 3.

Machine learning model 115 then generates a response (e.g., response 150) based on the augmented sequence of hidden representation tokens, where the response includes human-readable text. For example, response 150 includes the text string, “This document provides an overview of Natural Language Processing (NLP), a subfield of computer science and artificial intelligence that enables computers to process and understand human language . . . ” [remainder of response omitted for the sake of brevity]. User interface 110 displays the response on the user device. Response 150 is an example of, or includes aspects of, the corresponding element described with reference to FIG. 3.

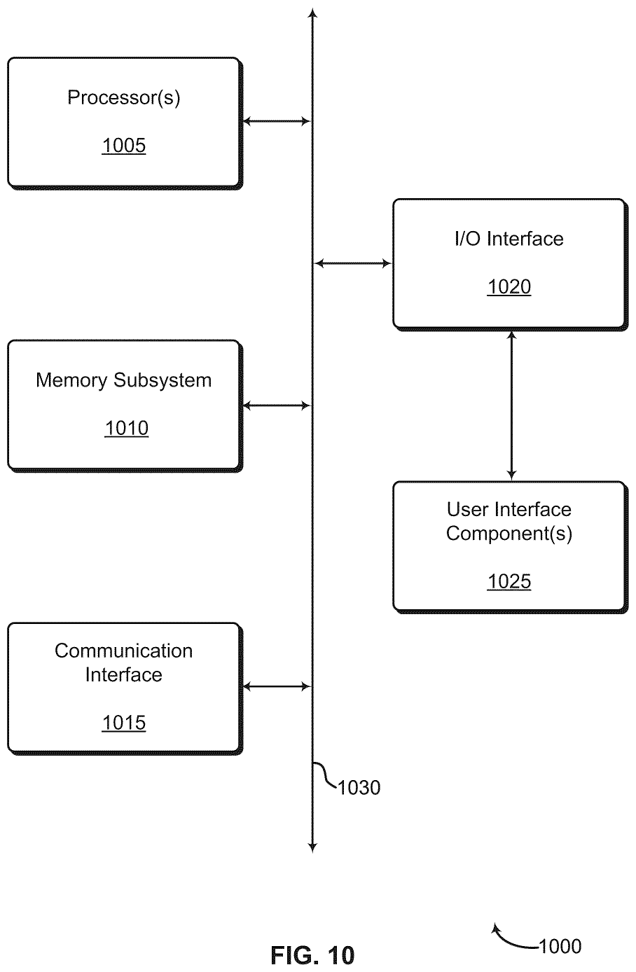

Data processing apparatus 105 is an example of, or includes aspects of, the corresponding element described with reference to FIGS. 3, 10, and 11. According to some aspects, data processing apparatus 105 includes a computer-implemented network. In some embodiments, the computer-implemented network includes machine learning model 115. Data processing apparatus 105 may also include one or more processors, a memory subsystem, a communication interface, an I/O interface, one or more user interface components, and a bus as described with reference to FIG. 10. Additionally, data processing apparatus 105 may communicate with the user device and database 125 via cloud 120.

According to some aspects, data processing apparatus 105 is implemented on a server. A server provides one or more functions to users linked by way of one or more of various networks, such as cloud 120. The server may include a microprocessor board that includes a microprocessor responsible for controlling all aspects of the server. The server uses the microprocessor and protocols such as hypertext transfer protocol (HTTP), simple mail transfer protocol (SMTP), file transfer protocol (FTP), and simple network management protocol (SNMP) to exchange data with other devices or users on one or more of the networks. The server may be configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

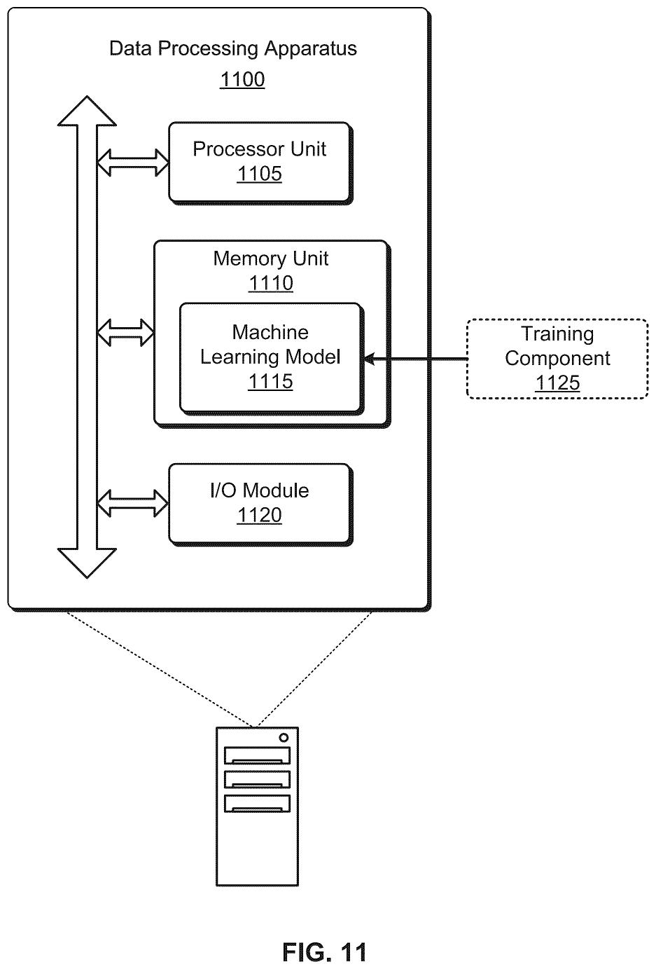

Machine learning model 115 is an example of, or includes aspects of, the corresponding element described with reference to FIGS. 3, 4, and 11. According to some aspects, machine learning model 115 comprises machine learning parameters stored in a memory unit of data processing apparatus 105 (such as the memory unit 1110 described with reference to FIG. 11). According to some aspects, machine learning model 115 comprises an artificial neural network (ANN) that is trained as described with reference to FIG. 9 to generate an output based on a prompt. In some aspects, machine learning model 115 includes a linear attention layer configured to perform a linear attention process. In some aspects, machine learning model 115 includes a gating layer configured to perform a gating process. In some aspects, machine learning model 115 includes a causal self-attention layer configured to perform a causal self-attention process. In some aspects, machine learning model 115 includes a state-space model.

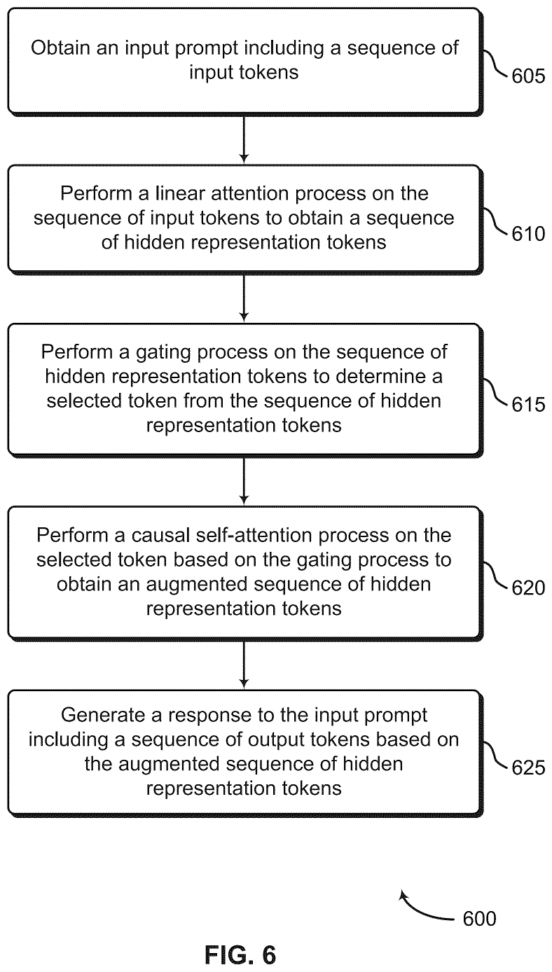

Further detail regarding the architecture of a data processing system are provided with reference to FIGS. 3-5 and 10-11. Further detail regarding a processes for generating a response is provided with reference to FIGS. 6-8. Further detail regarding a process for training a machine learning model is provided with reference to FIG. 9.

Cloud 120 is a computer network configured to provide on-demand availability of computer system resources, such as data storage and computing power. Cloud 120 may provide resources without active management by a user. The term “cloud” is sometimes used to describe data centers available to many users over the Internet. Some large cloud networks have functions distributed over multiple locations from central servers. A server is designated an edge server if the server has a direct or close connection to a user. Cloud 120 may be limited to a single organization or be available to many organizations. In one example, cloud 120 includes a multi-layer communications network comprising multiple edge routers and core routers. In another example, cloud 120 is based on a local collection of switches in a single physical location. According to some aspects, cloud 120 provides communications between data processing apparatus 105, database 125, and the user device.

Database 125 is an organized collection of data. In an example, database 125 stores data in a specified format known as a schema. According to some aspects, database 125 is structured as a single database, a distributed database, multiple distributed databases, or an emergency backup database. A database controller may manage data storage and processing in database 125. A user may interact with the database controller, or the database controller may operate automatically without interaction from the user. According to some aspects, database 125 is included in data processing apparatus 105. According to some aspects, database 125 is external to data processing apparatus 105 and communicates with data processing apparatus 105 via cloud 120.

According to some aspects, the user device is a personal computer, laptop computer, mainframe computer, palmtop computer, personal assistant, mobile device, or any other suitable processing apparatus. The user device may include software that displays user interface 110 provided by data processing apparatus 105. User interface 110 allows information to be communicated between the user and data processing apparatus 105. According to some aspects, user interface 110 comprises a text interface, a graphical user interface, or a combination thereof.

According to some aspects, a user device user interface enables a user to interact with the user device. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

FIG. 2 shows an example of a method 200 for generating a response using selective attention according to aspects of the present disclosure. Referring to FIG. 2, a data processing system (such as the data processing system 100 described with reference to FIG. 1) uses a selective attention process to determine which tokens of a sequence of input tokens to process using causal self-attention and which to process using only linear attention. The selective attention process effectively accounts for complex or long-range dependencies among tokens while maximizing computational efficiency by processing unselected tokens using linear attention. Therefore, the data processing system is able to efficiently generate an accurate response to an input prompt.

At operation 205, a user provides an input. In some cases, the operations of this step refer to, or may be performed by, a user as described with reference to FIG. 1. In an example, the user provides the input to a data processing apparatus of the data processing system via a user interface displayed by the data processing apparatus on a user device. In some embodiments, the input may include text, and may also include context, or information that can be used by a machine learning model in addition to information stored in a parametric memory of the machine learning model to generate a response. In the example of FIG. 2, the input includes the text string “Summarize this document” and a document (e.g., a PDF, a word processor document, a spreadsheet, an email, a file folder, etc.) to be used as context.

At operation 210, the system selects a set of tokens based on the text input. In some cases, the operations of this step refer to, or may be performed by, a data processing apparatus as described with reference to FIGS. 1, 3, 10, and 11. In an example, the data processing apparatus tokenizes the input and generates a sequence of hidden representation tokens based on the tokenized input using a linear attention process (e.g., a dot-product attention process) as described with reference to FIG. 3. The data processing apparatus selects the set of tokes from the sequence of hidden representation tokens using a gating process as described with reference to FIG. 3.

At operation 215, the system uses causal self attention on the selected tokens and linear attention on the other tokens. In some cases, the operations of this step refer to, or may be performed by, a data processing apparatus as described with reference to FIGS. 1, 3, 10, and 11. In an example, the data processing apparatus performs a causal self-attention process on the selected tokens while passing on the remainder of the sequence of hidden representation tokens to obtain an augmented sequence of hidden representation tokens as described with reference to FIG. 3.

At operation 220, the system generates a response. In some cases, the operations of this step refer to, or may be performed by, a data processing apparatus as described with reference to FIGS. 1, 3, 10, and 11. In an example, the data processing apparatus generates a text response based on the augmented sequence of hidden representation tokens as described with reference to FIG. 3. In the example of FIG. 2, the response includes the text, “This document provides an overview of Natural Language Processing (NLP), a subfield of computer science and artificial intelligence that enables computers to process and understand human language . . . ” [remainder of response omitted for the sake of brevity]. The data processing apparatus displays the response to the user via the user interface.

FIG. 3 shows an example of a data processing system 300 for performing selective attention according to aspects of the present disclosure. The example shown includes data processing system 300, input prompt 330, sequence of hidden representation tokens 340, selected token 345, augmented sequence of hidden representation tokens 350, and response 355. In one aspect, data processing system 300 includes data processing apparatus 305. In one aspect, data processing apparatus 305 includes machine learning model 310. In one aspect, machine learning model 310 includes linear attention layer 315, gating layer 320, and causal self-attention layer 325. In one aspect, input prompt 330 includes sequence of input tokens 335. In one aspect, response 355 includes sequence of output tokens 360.

Referring to FIG. 3, data processing apparatus 305 uses gating layer 320 to determine which tokens of a sequence of input tokens should be processed using causal self-attention layer 325. Gating layer 320 therefore allows causal self-attention to performed only for tokens that have complex, long-range dependencies with other tokens and would therefore benefit from a causal self-attention process, thereby minimizing information loss in a response while maximizing a computation efficiency of generating the response. A causal self-attention process and a linear attention process are discussed below, followed by a description of data processing system 300 for performing selective attention.

A causal self-attention process performed by causal self-attention layer 325 allows each token in a sequence to attend to all other previous tokens. Given an input sequence X=[x₁, . . . x_{L}]∈ [symbol] , where L is a length of the sequence and d is an embedding dimension, causal self-attention first computes the query vector qᵢ=W_{Q}xᵢ, the key vector kᵢ=W_{K}xᵢ, and the value vector vᵢ=W_{V}xᵢ for each token via linear projections from learnable weight matrices W_{Q}, W_{K}, W_{V}∈ [symbol] , respectively. Then, the attention output oᵢ for each token xᵢ is calculated as a weighted sum of the value vectors over the distribution of a similarity matrix between its query vector and previous key vectors, with a weight proportional to a similarity score between the tokens:

$${o}_{i} = {\sum }_{t = 1}^{i} \frac{exp ( {{q}_{i}}^{T} {k}_{t} / \sqrt{d} )}{{\sum }_{j = 1}^{i} exp ( {{q}_{i}}^{T} {k}_{t} / \sqrt{d} )} {v}_{t} \qquad ( 1 )$$

Equation 1 implements a form of self-attention called softmax attention in which the similarity score is the exponential of the dot product between a query and a key. The non-linear softmax distribution provided by Equation 1 allows a machine learning model to capture intricate relationships between tokens and concentrate on salient features, and causal self-attention layer 325 can therefore encode complex language patterns and long-range dependencies that are important for complex language understanding and generation tasks. However, causal self-attention has quadratic computational complexity such that memory requirements grow linearly with context length during inference, as the causal self-attention process stores key-value vectors for an entire context.

Meanwhile, linear attention as performed by linear attention layer 315 achieves linear complexity, instead of quadratic, by replacing the softmax attention of Equation 1 with dot-product attention. For example, given a feature transformation φ(x), causal self-attention can be rewritten as:

$${o}_{i} = {\sum }_{t = 1}^{i} \frac{{ϕ ( {q}_{i} )}^{T} ϕ ( {k}_{t} )}{{\sum }_{j = 1}^{i} {ϕ ( {q}_{i} )}^{T} ϕ ( {k}_{j} )} {v}_{t} \qquad ( 2 )$$

Then, using the associative property of matrix multiplication, Equation 2 can be reformulated as:

$${o}_{i} = \frac{{ϕ ( {q}_{i} )}^{T} {\sum }_{t = 1}^{i} ϕ ( {k}_{t} ) {{v}_{t}}^{T}}{{ϕ ( {q}_{i} )}^{T} {\sum }_{t = 1}^{i} ϕ ( {k}_{t} )} \qquad ( 3 )$$

Equation 3 represents dot-product attention, shown using matrix product via the transpose T of the matrices. In some embodiments, in contrast to the softmax attention used by causal self-attention, linear attention uses kernel-based methods or approximations to avoid direct pairwise interactions of tokens. For example, in some embodiments, instead of calculating all pairwise dot products of tokens in an input sequence, linear attention layer 315 expresses self-attention as a linear dot-product of kernel feature maps to reduce the quadratic complexity of causal self-attention to a linear complexity. For example, in Equation 3,

$${\sum }_{t = 1}^{i} ϕ ( {k}_{t} ) {{v}_{t}}^{T}$$

and

$${\sum }_{t = 1}^{i} ϕ ( {k}_{t} )$$

may be computed once and re-used for every query. Therefore, according to some aspects, Equation 3 describes dot-product attention, or a dot-product approximation.

Letting

$${s}_{i} = ϕ {( {q}_{i} )}^{T} {\sum }_{t = 1}^{i} ϕ ( {k}_{t} ) {v}_{t}^{T} and {z}_{i} = {\sum }_{t = 1}^{i} ϕ ( {k}_{t} ) ,$$

Equation 3 can be rewritten in a recurrent form:

$${S}_{i} = \frac{{S}_{i - 1} + ϕ ( {k}_{i} ) {v}_{i}^{T}}{ϕ {( {q}_{i} )}^{T} {\sum }_{t = 1}^{i} ϕ ( {k}_{t} )} \qquad ( 4 )$$

$${o}_{i} = \frac{{S}_{i} ϕ ( {q}_{i} )}{{z}_{i}^{T} ϕ ( {q}_{i} )} \approx {S}_{i} ϕ ( {q}_{i} ) \qquad ( 5 )$$

The formulation of Equation 5 allows for efficient training and inference. In some embodiments, a matrix multiplication form of Equation 5 is used by linear attention layer 315 to perform linear attention during training or inference:

$$O = ( {QK}^{T} ⊙ {M}_{L} ) V \qquad ( 6 )$$

In Equation 6, Q, K, V∈ [symbol] are query, key, and value matrices of a sequence input X (e.g., the sequence of input tokens), and M_{L} is a causal mask. A causal mask is a type of masking that encourages a machine learning model to attend to past and current tokens, not to future tokens ones (e.g., tokens following the token in an input sequence). Causal masking is useful for autoregressive models, which generate text one token at a time. The causal mask is typically a triangular matrix that prevents the attention mechanism from accessing future tokens. The causal mask assigns very large negative values (e.g., −∞) to attention scores for positions that should not be attended to. When passed through a softmax function, the large negative values turn into zeros, effectively blocking attention to future tokens.

Despite the computational efficiency due to linear complexity, the dot-product approximation used in some embodiments of linear attention lacks nonlinear normalization of softmax attention used in a causal self-attention process, often resulting in a more uniform distribution of attention weights that can impair a machine learning model's ability to focus sharply on specific and relevant tokens. Consequently, linear attention may underperform in tasks requiring precise in-context retrieval.

According to some aspects, linear attention layer 315 performs a generalization of a linear attention process. For example, in some embodiments, linear attention layer 315 comprises a structured state space model (SSM) that uses a data-dependent mechanism. Structured SSM s are a class of sequence models for deep learning that are broadly related to recurrent neural networks (RNNs), convolutional neural networks (CNNs), and classical state space models. Structured SSM s may map a one-dimensional sequence x∈ [symbol] →y∈ [symbol] through an implicit latent state h∈ [symbol] . A structured SSM may be defined using a recurrent form:

$${h}_{t} = {A}_{t} {h}_{t - 1} + {B}_{t} {x}_{t} \qquad ( 7 )$$

$${o}_{t} = {C}_{t} {h}_{t} \qquad ( 8 )$$

At is simplified to a scalar multiplied by the identity matrix, allowing Equations 7 and 8 to be interpreted as a generalization of linear attention. In some embodiments, the recurrence of Equations 7 and 8 are equivalently expressed as a matrix multiplication:

$$O = ( {L}_{t} ⊙ {C}_{t} {B}_{t}^{T} ) {X}_{t} \qquad ( 9 )$$

L is a 1-semiseperable matrix that encodes temporal dependencies, and CₜBₜ^{T} represents content-based interactions similar to attention. The matrix form of Equation 9 reveals a duality between recurrent (linear-time) and attention-like (quadratic-time) computations, therefore revealing connections between an SSM and linear attention through a framework of structured state-space duality (SSD). Equation 9 regularizes linear attention, which can be seen as a special case where L is the all-ones lower triangular matrix.

According to some aspects, linear attention layer 315 comprises a Mamba-2 block. Mamba-2 is a deep learning architecture designed to enhance sequence modeling by integrating SSM s with attention mechanisms through a framework of structured state-space duality (SSD), addressing limitations in traditional transformer models, particularly in handling long sequences. SSD unifies SSM s and attention mechanisms and allows the Mamba-2 architecture to leverage the strengths of both approaches, enhancing an ability to capture long-range dependencies in data. Mamba-2 may function as a linear recurrent neural network (RNN).

Mamba-2 achieves efficient computation by recasting its operations as matrix multiplications, an optimization which significantly speeds up training and inference. Compared to traditional transformers, Mamba-2 offers increased scalability, providing for linear scaling with sequence length and addressing the quadratic complexity typically associated with transformers. According to some aspects, Mamba-2 is a generalization of linear attention. In some embodiments, the Mamba-2 block including a depthwise convolutional layer, an SSM layer, and MLP layers.

According to some aspects, linear attention layer 315 receives a sequence of input tokens (e.g., sequence of input tokens 335) included in an input prompt 330. In some embodiments, the sequence of input tokens is a tokenized representation of an input (such as an input text). According to some aspects, data processing apparatus 305 tokenizes the input by converting raw text into a format suitable for processing by machine learning model 310. First, the input text undergoes normalization, such as conversion to lowercase letters, standardization of special characters, cleaning of whitespace, and the like.

Next, the formatted text is tokenized by breaking the formatted text into smaller units called tokens. These tokens can be whole words, subwords, or even individual characters, depending on the tokenizer type. For example, the sentence “Hello tokenization!” might initially be split into [“Hello”, “tokenization”, “!”]. The words of the input may be further divided into meaningful subunits. For example, “tokenization” might become [“token”, “ization”, “!”]. Each token may be mapped to a unique integer identifier. As used herein, the term “token” refers to either the token or the unique integer identifier for the token. Machine learning models process the unique integer identifiers.

Linear attention layer 315 performs linear attention on the sequence of input tokens to generate a sequence of hidden representation tokens (e.g., sequence of hidden representation tokens 340). Gating layer 320 determines a selected token of the sequence of hidden representation tokens (e.g., selected token 345).

In an example, for each hidden representation token hᵢ in the sequence of hidden representation tokens, gating layer 320 computes a score:

$${s}_{i} = {G}_{θ} ( {h}_{i} ) \qquad ( 10 )$$

Gating network G_{θ}: [symbol] → [symbol] is parameterized by θ. Gating layer 320 generates a binary mask mᵢ=argmax(GumbelSoftmax(sᵢ, τ)) during a forward pass. GumbelSoftmax is a Straight-Through Gumbel Softmax trick, a reparameterization trick that allows sampling from a categorical distribution in a differentiable manner. τ is a temperature parameter. As τ approaches 0, the distribution becomes more discrete, while higher values yield smoother sampling. Gating layer 320 selects each token of the sequence of hidden representation tokens with a non-zero mask value mᵢ. In some embodiments, the non-zero mask value is 1. Gating layer 320 comprises an artificial neural network trained as described with reference to FIG. 9.

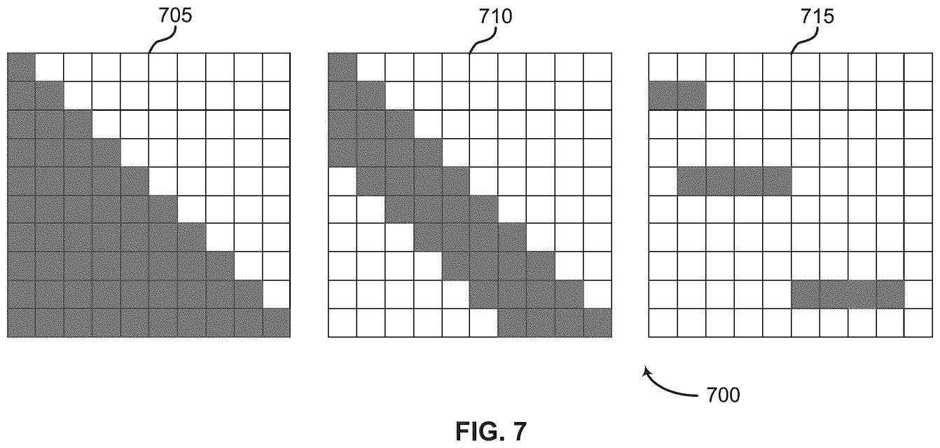

Causal self-attention layer 325 performs causal self-attention on the selected token hᵢ^{s} to obtain an augmented sequence of hidden representation tokens (e.g., augmented sequence of hidden representation tokens 350). For example, causal self-attention layer 325 uses Equation 1 to compute an attention-based augmented representation oᵢ (e.g., an augmented token), where qᵢ is the query vector for the i-th selected token and K and V are the key and value matrices, respectively, for previous tokens. According to some aspects, causal self-attention layer performs a causal self-attention process based on a sliding window attention as described with reference to FIG. 7. Causal self-attention layer 325 comprises an artificial neural network trained as described with reference to FIG. 9. In some embodiments, gating layer 320 and causal self-attention layer 325 are comprised in a selective attention layer.

According to some aspects, machine learning model 310 generates a response to the input prompt, where the response includes a sequence of output tokens based on the augmented sequence of hidden representation tokens. In an example, an output layer of machine learning model 310 transforms the augmented sequence of hidden representation tokens into the sequence of output tokens, where the sequence of output tokens includes human-readable words. In some embodiments, data processing apparatus 305 performs post-processing on the sequence of output tokens to present the sequence of output tokens as a text string.

According to some aspects, machine learning model 310 refines the augmented token by using the corresponding score sᵢ to compute a weighted combination h_{refined} of the augmented token oᵢ and the selected token

$${h}_{i}^{s} :$$

$${h}_{refined} = ( 1 - σ ( {s}_{i} ) ) {h}_{i}^{s} + σ ( {s}_{i} ) {o}_{i} \qquad ( 11 )$$

σ is the sigmoid function. The refined token h_{refined} allows machine learning model 310 to adaptively preserve key information from the selected token

$${h}_{i}^{s}$$

while enriching the representation with the attention output oᵢ, thereby increasing a capacity of machine learning model 310 to capture important dependencies among tokens. Accordingly, the score sᵢ acts as a data-dependent factor, filtering out unimportant features from the original representation

$${h}_{i}^{s}$$

while integrating richer information from the attention output oᵢ. In some embodiments, the output sequence of tokens is generated based on the refined token h_{refined}.

According to some aspects, machine learning model 310 performs a non-linear activation function on the augmented sequence of hidden representation tokens. For example, in some embodiments, each final token representation h of the selected tokens and the non-selected tokens (e.g., a hidden representation token, an augmented token, or a refined token as described above) is passed through a transformation layer, such as a multi-layer perceptron (MLP). In some aspects, the transformation layer comprises a gated linear unit (GLU), or a component-wise product of two linear transformations of an input, one of which is sigmoid-activated. In some aspects, the final transformation layer comprises a GLU variant of a combination of a component-wise product of a linear transformation and a non-linear activation function on the input, such as SwiGLU, which combines a linear transformation and a non-linear Swish activation function:

$$h = h + G L U ( h ) \qquad ( 12 )$$

The transformation layer provides processing (e.g., non-linear processing) for the final token representations before the final token representations are passed on to a next layer in machine learning model 310, thereby enhancing the ability of machine learning model 310 to capture complex dependencies.

According to some aspects, machine learning model 310 performs a subsequent linear attention process on the augmented sequence of hidden representation tokens. In an example, a subsequent linear attention layer receives the augmented sequence of hidden representation tokens, and the processes described herein repeat until each token in the input prompt is attended to, before the response is generated.

Therefore, according to some embodiments, during inference, machine learning model 310 processes input tokens sequentially through linear attention layer 315 (e.g., a Mamba-2 block). At gating layer 320, the gating network G_{θ} computes the score sᵢ=G_{θ}(hᵢ) for each token representation hᵢ. The score sᵢ determines the binary mask mᵢ=argmax(sᵢ) for selecting tokens for causal self-attention processing. Tokens with a non-zero mᵢ (e.g., mᵢ=1) undergo refinement and augmentation via the causal self-attention mechanism at causal self-attention layer 325, while non-selected tokens retain their original representations provided by linear attention layer 315. This selective approach preserves an efficiency of linear attention layer 315 for most tokens while applying targeted causal self-attention to tokens that would benefit from the target causal self-attention, enabling effective long-range dependency modeling with minimal computational overhead.

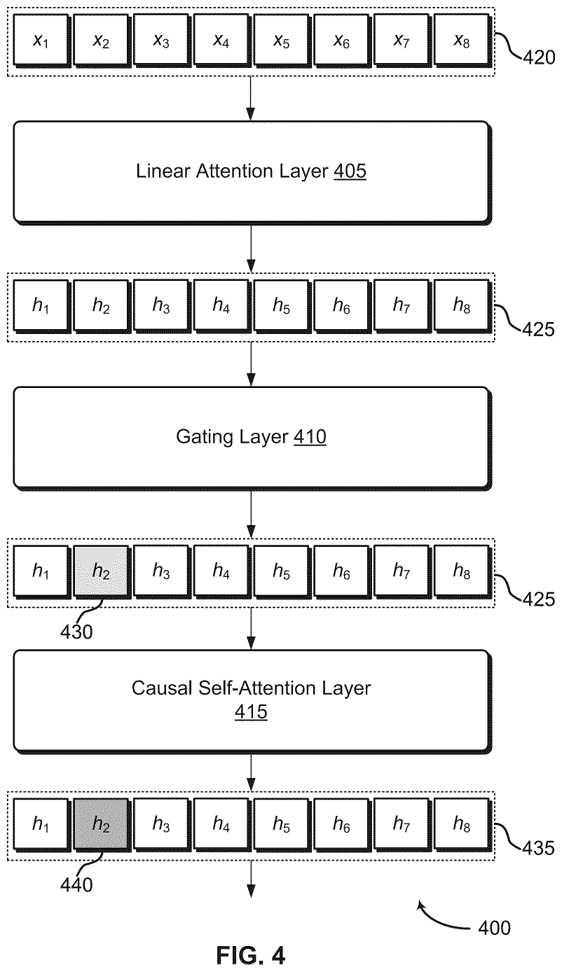

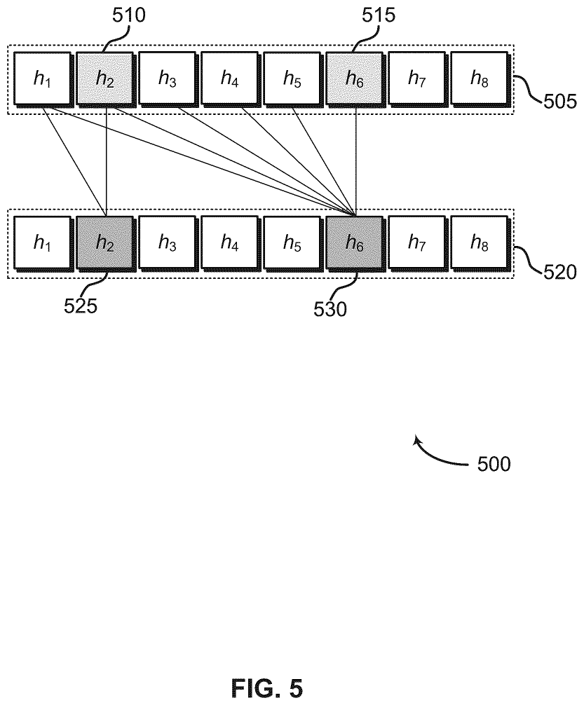

Data processing system 300 is an example of, or includes aspects of, the corresponding element described with reference to FIG. 1. Data processing apparatus 305 is an example of, or includes aspects of, the corresponding element described with reference to FIGS. 1, 10, and 11. Machine learning model 310 is an example of, or includes aspects of, the corresponding element described with reference to FIGS. 1, 4, and 11. Linear attention layer 315 and gating layer 320 are examples of, or include aspects of, the corresponding elements described with reference to FIG. 4. Causal self-attention layer 325 is an example of, or include aspects of, the corresponding elements described with reference to FIGS. 4 and 5.

Response 355 is an example of, or includes aspects of, the corresponding element described with reference to FIG. 1. Sequence of input tokens 335 is an example of, or includes aspects of, the corresponding element described with reference to FIG. 4. Selected token 345, sequence of hidden representation tokens 340, and augmented sequence of hidden representation tokens 350 are examples of, or include aspects of, the corresponding elements described with reference to FIGS. 4 and 5.

FIG. 4 shows an example of a machine learning model 400 according to aspects of the present disclosure. The example shown includes machine learning model 400, sequence of input tokens 420, sequence of hidden representation tokens 425, selected token 430, and augmented sequence of hidden representation tokens 435. In one aspect, machine learning model 400 includes linear attention layer 405, gating layer 410, and causal self-attention layer 415. In one aspect, augmented sequence of hidden representation tokens 435 includes augmented token 440.

Referring to FIG. 4, linear attention layer 405 performs a linear attention process (e.g., dot-product attention) on sequence of input tokens 420 to generate sequence of hidden representation tokens 425, as described with reference to FIG. 3. Gating layer 410 performs a gating process on sequence of hidden representation tokens 425 to select selected token 430 from sequence of hidden representation tokens 425, as described with reference to FIG. 3. Causal self-attention layer 415 performs a causal self-attention process (e.g., softmax attention) on selected token 430 to generate augmented token 440, as described with reference to FIG. 3, and replaces selected token 430 in sequence of hidden representation tokens 425 with augmented token 440 to obtain augmented sequence of hidden representation tokens 435. Augmented token 440 may be further refined as described with reference to FIG. 3, and augmented sequence of hidden representation tokens 435 may be provided to a transformation layer as described with reference to FIG. 3. Augmented sequence of hidden representation tokens 435, or the output of the transformation layer, may be used by another linear attention layer of machine learning model 400, and successively another gating layer and another causal self-attention layer, until each token in an input prompt (such as the input prompt 330 described with reference to FIG. 3) is attended to. An output layer of machine learning model 400 generates a human-readable response including text based on the processed tokens.

Accordingly, in some embodiments, machine learning model 400 comprises one or more sequences of layers, where each sequence of layers includes a linear attention layer followed by a gating layer followed by a causal self-attention layer. In some embodiments, the gating layer and the causal self-attention layer are comprised in a selective attention layer. In some embodiments, the gating layer and the causal-self attention layer, or the selective attention layer, are interleaved between a pair of linear attention layers.

Machine learning model 400 is an example of, or includes aspects of, the corresponding element described with reference to FIGS. 1, 3, and 11. Linear attention layer 405 and gating layer 410 are examples of, or include aspects of, the corresponding elements described with reference to FIG. 3. Causal self-attention layer 415 is an example of, or includes aspects of, the corresponding element described with reference to FIGS. 3 and 5.

Sequence of input tokens 420 is an example of, or includes aspects of, the corresponding element described with reference to FIG. 3. Selected token 430, sequence of hidden representation tokens 425, and augmented sequence of hidden representation tokens 435 are examples of, or includes aspects of, the corresponding elements described with reference to FIGS. 3 and 5. Augmented token 440 is an example of, or includes aspects of, the corresponding element described with reference to FIG. 5.

FIG. 5 shows an example of a causal self-attention process 500 according to aspects of the present disclosure. The example shown includes causal self-attention process 500, sequence of hidden representation tokens 505, and augmented sequence of hidden representation tokens 520. In one aspect, sequence of hidden representation tokens 505 includes first selected token 510 and second selected token 515. In one aspect, augmented sequence of hidden representation tokens 520 includes first augmented token 525 and second augmented token 530.

Referring to FIG. 5, in causal self-attention process 500 (e.g., a process performed by the causal self-attention layer 415 described with reference to FIG. 4), first selected token 510 attends to each previous token in sequence of hidden representation tokens 505 (e.g., using softmax attention) to obtain first augmented token 525, while second selected token 515 attends to each previous token in sequence of hidden representation tokens 505 to obtain second augmented token 530.

Sequence of hidden representation tokens 505, first selected token 510, and second selected token 515, and augmented sequence of hidden representation tokens 520 are examples of, or include aspects of, the corresponding elements described with reference to FIGS. 3 and 4. First augmented token 525 and second augmented token 530 are examples of, or include aspects of, the corresponding element described with reference to FIG. 5.

### Response Generation

FIG. 6 shows an example of a method 600 for generating a response using a gating process according to aspects of the present disclosure. Referring to FIG. 6, a data processing system (such as the data processing system 100 described with reference to FIG. 1) uses a combination of linear attention and causal self-attention to selectively process a sequence of tokens. Linear attention (e.g., dot-product attention), including a generalization of linear attention provided by a structured state-space model, is computationally efficient but produces sub-optimal results for tokens that have complex or long-range dependencies with other tokens. On the other hand, causal self-attention (e.g., softmax attention) effectively accounts for complex or long-range dependencies among tokens, but is computationally inefficient compared to linear attention. By using a gating process to select tokens that would benefit from causal self-attention, the data processing system effectively accounts for complex or long-range dependencies among tokens while maximizing computational efficiency. Therefore, data processing system 100 is able to efficiently generate an accurate response to an input prompt.

At operation 605, the system obtains an input prompt including a sequence of input tokens. In some cases, the operations of this step refer to, or may be performed by, a data processing apparatus as described with reference to FIGS. 1, 3, 10, and 11. In some embodiments, the input prompt comprises a tokenization of input text (such as input text provided by a user as described with reference to FIG. 1) as described with reference to FIG. 3. The sequence of input tokens comprises at least a portion of the input prompt.

At operation 610, the system performs, using a machine learning model, a linear attention process on the sequence of input tokens to obtain a sequence of hidden representation tokens. In some cases, the operations of this step refer to, or may be performed by, a machine learning model as described with reference to FIGS. 1, 3, 4, and 11. According to some aspects, the machine learning model obtains the sequence of hidden representation tokens using a linear attention layer as described with reference to FIG. 3. For example, in some embodiments, performing the linear attention process includes computing a dot product of an attention score matrix.

At operation 615, the system performs, using the machine learning model, a gating process on the sequence of hidden representation tokens to determine a selected token from the sequence of hidden representation tokens. In some cases, the operations of this step refer to, or may be performed by, a machine learning model as described with reference to FIGS. 1, 3, 4, and 11. According to some aspects, the machine learning model determines the selected token using a gating layer as described with reference to FIG. 3. For example, in some embodiments, performing the gating process includes computing binary mask for the sequence of hidden representation tokens, wherein the selected token corresponds to a non-zero value of the binary mask.

At operation 620, the system performs, using the machine learning model, a causal self-attention process on the selected token based on the gating process to obtain an augmented sequence of hidden representation tokens. In some cases, the operations of this step refer to, or may be performed by, a machine learning model as described with reference to FIGS. 1, 3, 4, and 11. According to some aspects, the machine learning model obtains the augmented sequence of hidden representation tokens using a causal self-attention layer as described with reference to FIG. 3.

For example, in some embodiments, performing the causal self-attention process includes computing a softmax normalization of an attention score matrix. In some embodiments, performing the causal self-attention process includes computing an augmented token corresponding to the selected token, where the augmented sequence of hidden representation tokens includes the augmented token. In some embodiments, the machine learning model computes a weighted combination of the augmented token and the selected token. In some embodiments, performing the causal self-attention process includes performing sliding window attention as described with reference to FIG. 7.

At operation 625, the system generates, using the machine learning model, a response to the input prompt including a sequence of output tokens based on the augmented sequence of hidden representation tokens. In some cases, the operations of this step refer to, or may be performed by, a machine learning model as described with reference to FIGS. 1, 3, 4, and 11. According to some aspects, the machine learning model generates the response using an output layer as described with reference to FIG. 3.

FIG. 7 shows a comparative example 700 of attention maps according to aspects of the present disclosure. The example shown includes full causal self-attention map 705, standard sliding window attention map 710, and selective causal self-attention map 715.

Referring to FIG. 7, according to some aspects, to maintain linear time complexity while leveraging benefits of attention, a machine learning model (such as the machine learning model 115 described with reference to FIG. 1) employs a combination of selective causal self-attention (e.g., causal self-attention applied to selected tokens, as described with reference to FIG. 3) and sliding window attention (SWA). In SWA, given a fixed window size w of the machine learning model, each token attends to ½w tokens on each side. A computational complexity of SWA scales linearly with sequence length, enabling efficient processing and generation of long sequences, allowing the machine learning model to handle theoretically unlimited context lengths during inference.

In some embodiments, the combination of selective causal self-attention and SWA leads to a significantly sparser attention weight map compared to full causal self-attention or standard SWA, thus enhancing a computational efficiency of selective causal self-attention for processing long sequences. In addition, the sparser attention map allows the machine learning model to afford a longer sliding window (e.g., w=2048) to effectively capture longer-range dependencies for input sequences. In this way, the machine learning model includes a mechanism to balance an efficient processing of long sequences with an ability to capture important long-range dependencies when necessary, thereby addressing a key limitation of existing efficient attention mechanisms. Finally, in some embodiments, removing positional embeddings from the causal self-attention layer of the machine learning model increases extrapolation capabilities of the machine learning model, thereby allowing the machine learning model to better generalize temporal relationships between tokens.

As shown in FIG. 7, white areas in full causal self-attention map 705, standard sliding window attention map 710, and selective causal self-attention map 715 indicate no attention. Standard sliding window attention map 710 as shown includes w=4, while selective causal self-attention map 715 includes w=5 and budget constraint C=0.3. The budget constraint is described in further detail with reference to FIG. 9.

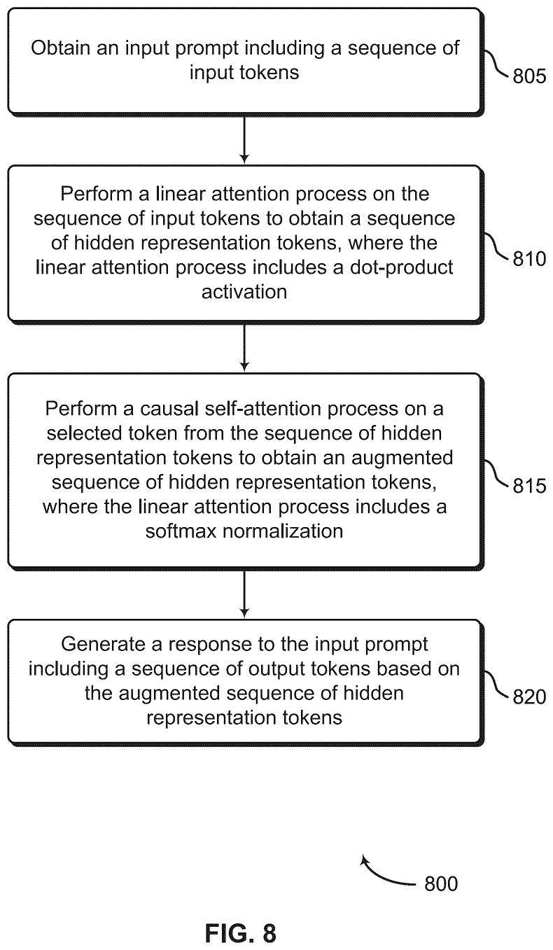

FIG. 8 shows an example of a method 800 for generating a response using a selected token according to aspects of the present disclosure.

At operation 805, the system obtains an input prompt including a sequence of input tokens. In some cases, the operations of this step refer to, or may be performed by, a data processing apparatus as described with reference to FIGS. 1, 3, 10, and 11. In some embodiments, the input prompt comprises a tokenization of input text (such as input text provided by a user as described with reference to FIG. 1) as described with reference to FIG. 3. The sequence of input tokens comprises at least a portion of the input prompt.

At operation 810, the system performs, using a machine learning model, a linear attention process on the sequence of input tokens to obtain a sequence of hidden representation tokens, where the linear attention process includes a dot-product activation. In some cases, the operations of this step refer to, or may be performed by, a machine learning model as described with reference to FIGS. 1, 3, 4, and 11. According to some aspects, the machine learning model obtains the sequence of hidden representation tokens using a linear attention layer as described with reference to FIG. 3.

At operation 815, the system performs, using the machine learning model, a causal self-attention process on a selected token from the sequence of hidden representation tokens to obtain an augmented sequence of hidden representation tokens, where the linear attention process includes a softmax normalization. In some cases, the operations of this step refer to, or may be performed by, a machine learning model as described with reference to FIGS. 1, 3, 4, and 11. According to some aspects, the machine learning model determines the selected token using a gating layer as described with reference to FIG. 3. According to some aspects, the machine learning model obtains the augmented sequence of hidden representation tokens using a causal self-attention layer as described with reference to FIG. 3.

At operation 820, the system generates, using the machine learning model, a response to the input prompt including a sequence of output tokens based on the augmented sequence of hidden representation tokens. In some cases, the operations of this step refer to, or may be performed by, a machine learning model as described with reference to FIGS. 1, 3, 4, and 11. According to some aspects, the machine learning model generates the response using an output layer as described with reference to FIG. 3.

Accordingly, a method for data processing is described. One or more aspects of the method include obtaining an input prompt comprising a sequence of input tokens; performing, using a machine learning model, a linear attention process on the sequence of input tokens to obtain a sequence of hidden representation tokens; performing, using the machine learning model, a gating process on the sequence of hidden representation tokens to determine a selected token from the sequence of hidden representation tokens; performing, using the machine learning model, a causal self-attention process on the selected token based on the gating process to obtain an augmented sequence of hidden representation tokens; and generating, using the machine learning model, a response to the input prompt comprising a sequence of output tokens based on the augmented sequence of hidden representation tokens.

In some examples, performing the linear attention process includes computing a dot product of an attention score matrix. In some examples, performing the gating process includes computing a binary mask for the sequence of hidden representation tokens, wherein the selected token corresponds to a non-zero value of the binary mask. In some examples, performing the causal self-attention process includes computing a softmax normalization of an attention score matrix. In some examples, performing the causal self-attention process includes computing an augmented token corresponding to the selected token. Some examples of the method further include computing a weighted combination of the augmented token and the selected token. In some examples, performing the causal self-attention process includes performing sliding window attention.

Some examples of the method further include performing a subsequent linear attention process on the augmented sequence of hidden representation tokens. Some examples of the method further include performing a non-linear activation function on the augmented sequence of hidden representation tokens. In some aspects, the machine learning model is trained using a constraint loss that is based on a budget parameter representing a fraction of tokens subject to the causal self-attention process.

Furthermore, a method for data processing is described. One or more aspects of the method include obtaining an input prompt comprising a sequence of input tokens; performing, using a machine learning model, a linear attention process on the sequence of input tokens to obtain a sequence of hidden representation tokens, wherein the linear attention process comprises a dot-product activation; performing, using the machine learning model, a causal self-attention process on a selected token from the sequence of hidden representation tokens to obtain an augmented sequence of hidden representation tokens, wherein the linear attention process comprises a softmax normalization; and generating, using the machine learning model, a response to the input prompt comprising a sequence of output tokens based on the augmented sequence of hidden representation tokens.

Some examples of the method further include computing a binary mask for the sequence of hidden representation tokens, wherein the selected token corresponds to a non-zero value of the binary mask. In some examples, performing the causal self-attention process includes computing an augmented token corresponding to the selected token. Some examples of the method further include computing a weighted combination of the augmented token and the selected token. In some examples, performing the causal self-attention process includes performing sliding window attention.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Training

FIG. 9 shows an example of a flow diagram depicting an algorithm as a step-by-step procedure 900 for training a machine learning model according to aspects of the present disclosure. In some embodiments, the procedure 900 describes an operation of the training component 1125 described for configuring the machine learning model 1115 as described with reference to FIG. 11. The procedure 900 provides one or more examples of generating training data, use of the training data to train a machine learning model, and use of the trained machine learning model to perform a task.

To begin in this example, a machine learning system collects training data (block 902) that is to be used as a basis to train a machine learning model, i.e., which defines what is being modeled. The training data is collectable by the machine learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine learning system is also configurable to identify features that are relevant (block 904) to a type of task, for which the machine learning model is to be trained. Task examples include classification, natural language processing, generative artificial intelligence, recommendation engines, reinforcement learning, clustering, and so forth. To do so, the machine learning system collects the training data based on the identified features and/or filters the training data based on the identified features after collection. The training data is then utilized to train a machine learning model.

In order to train the machine learning model in the illustrated example, the machine learning model is first initialized (block 906). Initialization of the machine learning model includes selecting a model architecture (block 908) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 910). The loss function is utilized to measure a difference between an output of the machine learning model (i.e., predictions) and target values (e.g., as expressed by the training data) to be used to train the machine learning model. Additionally, an optimization algorithm is selected (912) that is to be used in conjunction with the loss function to optimize parameters of the machine learning model during training, examples of which include gradient descent, stochastic gradient descent (SGD), and so forth.

Initialization of the machine learning model further includes setting initial values of the machine learning model (block 914) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine learning model is then trained using the training data (block 918) by the machine learning system. A machine learning model refers to a computer representation that can be tuned (e.g., trained and retrained) based on inputs of the training data to approximate unknown functions. In particular, the term machine learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine learning model to perform an associated task.

As part of training the machine learning model, a determination is made as to whether a stopping criterion is met (decision block 920), i.e., which is used to validate the machine learning model. The stopping criterion is usable to reduce overfitting of the machine learning model, reduce computational resource consumption, and promote an ability of the machine learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1220), the procedure 900 continues training of the machine learning model using the training data (block 1218) in this example.

If the stopping criterion is met (“yes” from decision block 920), the trained machine learning model is then utilized to generate an output based on subsequent data (block 922). The trained machine learning model, for instance, is trained to perform a task as described above and therefore once trained is configured to perform that task based on subsequent data received as an input and processed by the machine learning model.

According to some aspects, the machine learning model is trained based on an attention budget constraint. For example, given a predefined budget C representing a desired fraction of tokens to receive attention, a constraint loss is incorporated into the training objective for the machine learning model:

$${ℒ}_{constraint} = {\sum }_{N} {‖ C - \frac{{\sum }_{i = 1}^{L} {m}_{i}}{L} ‖}_{2}^{2} \qquad ( 13 )$$

N is the number of gating layers or causal self-attention layers of the machine learning model (or selective attention layers comprising the gating layers and causal self-attention layers), L is the input sequence length, and

$${\sum }_{i = 1}^{L} {m}_{i}$$

represents the number of selected tokens. Accordingly, the overall training objective for the machine learning model includes a standard cross-entropy loss L_{CE} for language modeling and the budget constraint term:

$$ℒ = {ℒ}_{CE} + {λℒ}_{constraint} \qquad ( 14 )$$

λ is a hyperparameter.

During training, the machine learning model leverages the straight-through Gumbel-softmax trick to differentiably select tokens for causal self-attention. The straight-through Gumbel-softmax trick uses binary values (0 or 1) in the forward pass, maintaining discrete token selection. In a backward pass of a gating layer (such as the gating layer 320 described with reference to FIG. 3), soft probability values are employed for gradient computation:

$${\tilde{m}}_{i} = \frac{exp ( ( {s}_{i} + {g}_{i} ) / τ )}{{\sum }_{j} exp ( ( {s}_{i} + {g}_{i} ) / τ )} \qquad ( 15 )$$

sᵢ is the score described with reference to FIG. 3, gᵢ is an i.i.d sample from Gumbel(0,1) distribution, and t is the temperature parameter described with reference to FIG. 3. Equation 15 allows for end-to-end training of the machine learning model, including the parameters for the gating network G_{θ} described with reference to FIG. 3, while preserving the discrete nature of token selection during inference. The straight-through Gumbel-softmax trick (e.g., the straight-through estimator) enables the propagation of gradients through the non-differentiable argmax operation, facilitating the learning of the gating process, including score generation, alongside the main machine learning model parameters.

According to some aspects, the data processing system is compared against baseline systems including a baseline transformer, a baseline Mamba-2 model, and a baseline hybrid model that includes a causal self-attention layer and a Mamba-2 layer but does not select tokens to be processed by the causal self-attention layer, retains positional embeddings, and lacks a feature refinement mechanism.

The data processing system outperforms the baseline systems on a zero-shot language understanding task, with a widening performance gap as model size increases. Furthermore, the data processing system outperforms the Mama-2 and hybrid baselines on an in-context retrieval task. While the baseline transformer excels at memory-intensive tasks, the baseline transformer is constrained by linear memory scaling with sequence length, limiting an effectiveness of the transformer for processing very long sequences. In contrast, the data processing system maintains constant memory usage regardless of sequence length, offering a more efficient solution for processing extensive documents. Finally, the data processing system outperforms the baseline models in a long-context extrapolation task, demonstrating a lowest latency among the tested models, with linear scaling across sequence lengths.

### Data Processing Apparatus

FIG. 10 shows an example of a computing device according to aspects of the present disclosure. Computing device 1000 is an example of, or includes aspects of, the data processing apparatus described with reference to FIGS. 1, 3, and 11. In one aspect, computing device 1000 includes processor(s) 1005, memory subsystem 1010, communication interface 1015, I/O interface 1020, user interface component(s) 1025, and channel 1030. In some embodiments, computing device 1000 includes one or more processors 1005 that can execute instructions stored in memory subsystem 1010.

According to some aspects, computing device 1000 includes one or more processors 1005. In some cases, a processor is an intelligent hardware device, (e.g., a general-purpose processing component, a digital signal processor (DSP), a central processing unit (CPU), a graphics processing unit (GPU), a microcontroller, an application specific integrated circuit (A SIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1010 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1015 operates at a boundary between communicating entities (such as computing device 1000, one or more user devices, a cloud, and one or more databases) and channel 1030 and can record and process communications. In some cases, communication interface 1015 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1020 is controlled by an I/O controller to manage input and output signals for computing device 1000. In some cases, I/O interface 1020 manages peripherals not integrated into computing device 1000. In some cases, I/O interface 1020 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1020 or via hardware components controlled by the I/O controller.

According to some aspects, user interface component(s) 1025 enable a user to interact with computing device 1000. In some cases, user interface component(s) 1025 include an audio device, such as an external speaker system, an external display device such as a display screen, an input device (e.g., a remote-control device interfaced with a user interface directly or through the I/O controller), or a combination thereof. In some cases, user interface component(s) 1025 include a GUI.

FIG. 11 shows an example of a data processing apparatus 1100 according to aspects of the present disclosure. Data processing apparatus 1100 is an example of, or includes aspects of, the corresponding element described with reference to FIGS. 1, 3, and 10. In some embodiments, data processing apparatus 1100 includes processor unit 1105, memory unit 1110, machine learning model 1115, I/O module 1120, and training component 1125. Training component 1125 updates parameters of the machine learning model 1115 stored in memory unit 1110. In some examples, the training component 1125 is located outside the data processing apparatus 1100.

Processor unit 1105 includes one or more processors. A processor is an intelligent hardware device, such as a general-purpose processing component, a digital signal processor (DSP), a central processing unit (CPU), a graphics processing unit (GPU), a microcontroller, an application specific integrated circuit (A SIC), a field programmable gate array (FPGA), a programmable logic device, a discrete gate or transistor logic component, a discrete hardware component, or any combination thereof.

In some cases, processor unit 1105 is configured to operate a memory array using a memory controller. In other cases, a memory controller is integrated into processor unit 1105. In some cases, processor unit 1105 is configured to execute computer-readable instructions stored in memory unit 1110 to perform various functions. In some aspects, processor unit 1105 includes special purpose components for modem processing, baseband processing, digital signal processing, or transmission processing. According to some aspects, processor unit 1105 comprises one or more processors 1005 described with reference to FIG. 10.

Memory unit 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1105 to perform various functions described herein.

In some cases, memory unit 1110 includes a basic input/output system (BIOS) that controls basic hardware or software operations, such as an interaction with peripheral components or devices. In some cases, memory unit 1110 includes a memory controller that operates memory cells of memory unit 1110. For example, the memory controller may include a row decoder, column decoder, or both. In some cases, memory cells within memory unit 1110 store information in the form of a logical state. According to some aspects, memory unit 1110 is an example of the memory subsystem 1010 described with reference to FIG. 10.

According to some aspects, data processing apparatus 1100 uses one or more processors of processor unit 1105 to execute instructions stored in memory unit 1110 to perform functions described herein. For example, the data processing apparatus 1100 may perform operations comprising obtaining an input prompt comprising a sequence of input tokens; performing, using a machine learning model, a linear attention process on the sequence of input tokens to obtain a sequence of hidden representation tokens; performing, using the machine learning model, a gating process on the sequence of hidden representation tokens to determine a selected token from the sequence of hidden representation tokens; performing, using the machine learning model, a causal self-attention process on the selected token based on the gating process to obtain an augmented sequence of hidden representation tokens; and generating, using the machine learning model, a response to the input prompt comprising a sequence of output tokens based on the augmented sequence of hidden representation tokens.

The memory unit 1110 may include a machine learning model 1115. According to some aspects, machine learning model 1115 comprises machine learning parameters stored in memory unit 1110. Machine learning model 1115 is an example of, or includes aspects of, the corresponding element described with reference to FIGS. 1, 3, and 4. In some aspects, the machine learning model comprises a linear attention layer configured to perform the linear attention process.

In some embodiments, the machine learning model 1115 is an artificial neural network (ANN). An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the machine learning model 1115 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1125 may train the machine learning model 1115. For example, parameters of the machine learning model 1115 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 9). The goal of the training process may be to find optimal values for the parameters that allow the machine learning model 1115 to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model 1115 can be used to make predictions on new, unseen data (i.e., during inference).

I/O module 1120 receives inputs from and transmits outputs of the data processing apparatus 1100 to other devices or users. For example, I/O module 1120 receives inputs for the machine learning model 1115 and transmits outputs of the machine learning model 1115. According to some aspects, I/O module 1120 is an example of the I/O interface 1020 described with reference to FIG. 10.

According to some aspects, training component 1125 comprises executable code (e.g., software) stored in memory unit 1110, firmware, one or more hardware circuits, or a combination thereof.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application-specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or Y Z or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for data processing, comprising:
obtaining an input prompt comprising a sequence of input tokens;
performing, using a machine learning model, a linear attention process on the sequence of input tokens to obtain a sequence of hidden representation tokens;
performing, using the machine learning model, a gating process on the sequence of hidden representation tokens to determine a selected token from the sequence of hidden representation tokens;
performing, using the machine learning model, a causal self-attention process on the selected token based on the gating process to obtain an augmented sequence of hidden representation tokens; and
generating, using the machine learning model, a response to the input prompt comprising a sequence of output tokens based on the augmented sequence of hidden representation tokens.

2. The method of claim 1, wherein performing the linear attention process comprises:
computing a dot product of an attention score matrix.

3. The method of claim 1, wherein performing the gating process comprises:
computing a binary mask for the sequence of hidden representation tokens, wherein the selected token corresponds to a non-zero value of the binary mask.

4. The method of claim 1, wherein performing the causal self-attention process comprises:
computing a softmax normalization of an attention score matrix.

5. The method of claim 1, wherein performing the causal self-attention process comprises:
computing an augmented token corresponding to the selected token.

6. The method of claim 5, further comprising:
computing a weighted combination of the augmented token and the selected token.

7. The method of claim 1, wherein performing the causal self-attention process comprises:
performing sliding window attention.

8. The method of claim 1, further comprising:
performing a subsequent linear attention process on the augmented sequence of hidden representation tokens.

9. The method of claim 1, further comprising:
performing a non-linear activation function on the augmented sequence of hidden representation tokens.

10. The method of claim 1, wherein:
the machine learning model is trained using a constraint loss that is based on a budget parameter representing a fraction of tokens subject to the causal self-attention process.

11. A non-transitory computer readable medium storing code for data processing, the code comprising instructions that, when executed by at least one processor, cause the at least one processor to perform operations comprising:
obtaining an input prompt comprising a sequence of input tokens;
performing, using a machine learning model, a linear attention process on the sequence of input tokens to obtain a sequence of hidden representation tokens, wherein the linear attention process comprises a dot-product activation;
performing, using the machine learning model, a causal self-attention process on a selected token from the sequence of hidden representation tokens to obtain an augmented sequence of hidden representation tokens, wherein the linear attention process comprises a softmax normalization; and
generating, using the machine learning model, a response to the input prompt comprising a sequence of output tokens based on the augmented sequence of hidden representation tokens.

12. The non-transitory computer readable medium of claim 11, the code further comprising instructions that, when executed by the at least one processor, cause the at least one processor to perform operations comprising:
computing a binary mask for the sequence of hidden representation tokens, wherein the selected token corresponds to a non-zero value of the binary mask.

13. The non-transitory computer readable medium of claim 11, wherein performing the causal self-attention process comprises:
computing an augmented token corresponding to the selected token.

14. The non-transitory computer readable medium of claim 13, the code further comprising instructions that, when executed by the at least one processor, cause the at least one processor to perform operations comprising:
computing a weighted combination of the augmented token and the selected token.

15. The non-transitory computer readable medium of claim 11, wherein performing the causal self-attention process comprises:
performing sliding window attention.

16. A system comprising:
a memory component; and
a processing device coupled to the memory component, the processing device configured to perform operations comprising:
obtaining an input prompt comprising a sequence of input tokens;
performing, using a machine learning model, a linear attention process on the sequence of input tokens to obtain a sequence of hidden representation tokens;
performing, using the machine learning model, a gating process on the sequence of hidden representation tokens to determine a selected token from the sequence of hidden representation tokens;
performing, using the machine learning model, a causal self-attention process on the selected token based on the gating process to obtain an augmented sequence of hidden representation tokens; and
generating, using the machine learning model, a response to the input prompt comprising a sequence of output tokens based on the augmented sequence of hidden representation tokens.

17. The system of claim 16, wherein:
the machine learning model comprises a linear attention layer configured to perform the linear attention process.

18. The system of claim 16, wherein:
the machine learning model comprises a gating layer configured to perform the gating process.

19. The system of claim 16, wherein:
the machine learning model comprises a causal self-attention layer configured to perform the causal self-attention process.

20. The system of claim 16, wherein:
the machine learning model comprises a state-space model.
